(19) United States
(12) Patent Application Publication
(10) Pub. No.: US 2024/0372708 A1
(43) Pub. Date: Nov. 7, 2024

(54) SECURE CONJUGATE GRADIENT METHOD COMPUTATION METHOD, SECURE CONJUGATE GRADIENT METHOD COMPUTATION SYSTEM, SECURE COMPUTATION APPARATUS, AND PROGRAM

(71) Applicant: NIPPON TELEGRAPH AND TELEPHONE CORPORATION, Tokyo (JP)

(72) Inventors: Takumi FUKAMI, Musashino-shi, Tokyo (JP); Dai IKARASHI, Musashino-shi, Tokyo (JP); Iifan TYOU, Musashino-shi, Tokyo (JP)

(73) Assignee: NIPPON TELEGRAPH AND TELEPHONE CORPORATION, Tokyo (JP)

(21) Appl. No.: 18/565,929

(22) PCT Filed: Jun. 2, 2021
(86) PCT No.: PCT/JP2021/020959

§ 371 Date: Nov. 30, 2023

(51) Int. Cl. H04L 9/08; G06F 17/12; G06F 17/16

(52) U.S. Cl. CPC H04L 9/085; G06F 17/12; G06F 17/16

(57) ABSTRACT

A method and circuitry to calculate a simultaneous linear equation with a plurality of symmetric positive definite matrices as coefficients. N symmetric positive definite matrices A^{˜} and N vectors B are input to input circuitry. Initialization circuitry initializes secret values of matrices X, R, and P and a vector γ^{→}. First calculation circuitry collectively calculates N matrix calculations to generate a secret value of a vector α^{→}. Second calculation circuitry updates the secret value of the matrix X. Third calculation circuitry collectively calculates N matrix calculations to update the secret value of the matrix R. Fourth calculation circuitry collectively calculates an inner product of N vectors to generate a secret value of the vector β^{→}. Fifth calculation circuitry updates the secret value of the matrix P, and sixth calculation circuitry collectively calculates the inner product of the N vectors and updates the secret value of the vector γ^{→}.

### TECHNICAL FIELD

The present invention relates to a secure computation technology, and more particularly, to a technology for securely computing a conjugate gradient method.

### BACKGROUND ART

A conjugate gradient method is an algorithm for solving a simultaneous linear equation with symmetric positive definite matrices as coefficients. The conjugate gradient method is a technique of directly calculating A⁻¹b^{→} without calculating an inverse matrix A⁻¹ of a symmetric positive definite matrix A when the symmetric positive definite matrix A and a vector b^{→} are given. The conjugate gradient method is often used in machine learning and the like.

When machine learning is performed by secure computation, it is necessary to calculate a conjugate gradient method efficiently. Patent literature 1 discloses a technology for efficiently calculating a conjugate gradient method by secure computation.

### PRIOR ART LITERATURE

### Patent Literature

Patent literature 1: International Publication No. 2020/246018

### SUMMARY OF THE INVENTION

### Problems to be Solved by the Invention

The prior art described in Patent literature 1 is a technology for efficiently calculating a conjugate gradient method for a set of a symmetric positive definite matrix and a vector. Therefore, it is necessary to calculate the conjugate gradient method N times in order to apply the conjugate gradient method for N sets of symmetric positive definite matrices and vectors using the prior art described in Patent Literature 1, and processing time increases at O (N).

In view of the above technical problems, an object of the present invention is to efficiently calculate a conjugate gradient method for a plurality of sets of symmetric positive definite matrices and vectors.

### Means to Solve the Problems

A secure conjugate gradient method computation method for receiving a secret value of a multi-dimensional matrix A˜ consisting of N symmetric positive definite matrices A₁, A₂, . . . , A_{N} and a secret value of a matrix B consisting of N vectors b^{→}₁, . . . , b^{→}_{N} and outputting a secret value of a matrix X consisting of A₁⁻¹b^{→}₁, . . . , A_{N}⁻¹b^{→}_{N}, the secure conjugate gradient method computation method being executed by a secure conjugate gradient method computation system including a plurality of secure computation apparatuses, wherein ⋅^{T} represents a transpose of a matrix ⋅, diag (⋅) represents a function for outputting diagonal elements of the matrix ⋅, n represents a predetermined natural number, and 0ⁿ represents a vector having a length of n with all elements being 0, an initialization unit of each secure computation apparatus securely computes the following formulas to generate a secret value of the matrix X, a secret value of a matrix R=(r^{→}₁, . . . , r^{→}_{N}), a secret value of a matrix P=(p^{→}₁, . . . , p^{→}_{N})), and a secret value of a vector γ^{→}

$$X ← ( {0}^{n} , {0}^{n} , … , {0}^{n} ) R , P ← B \vec{γ} ← diag ( {R}^{T} R ) , \qquad [ Math . 1 ]$$

a first calculation unit of each secure computation apparatus securely computes the following formula so that communication required for matrix calculation is collectively performed once for integer i equal to or greater than 1 or equal to or smaller than N, to generate a secret value of a vector α^{→}=(α₁, . . . , α_{N})

$${α}_{i} ← \frac{{\vec{r}}_{i}^{T} \vec{p} i}{{\vec{p}}_{i}^{T} {A}_{i} {\vec{p}}_{i}} , \qquad [ Math . 2 ]$$

a second calculation unit of each secure computation apparatus securely computes the following formula to update the secret value of the matrix X

$$X ← X + {\vec{α}}^{T} P , \qquad [ Math . 3 ]$$

a third calculation unit of each secure computation apparatus securely computes the following formula so that the communication required for the matrix calculation is collectively performed once for integer i equal to or greater than 1 or equal to or smaller than N, to update a secret value of the matrix R

$${\vec{r}}_{i} ← {\vec{r}}_{i} - {α}_{i} {A}_{i} {\vec{p}}_{i} , \qquad [ Math . 4 ]$$

a fourth calculation unit of each secure computation apparatus securely computes the following formula while converting multiplication of N values into element-wise multiplication one vector to generate a secret value of the vector B^{→}

$$\vec{β} ← diag ( {R}^{T} R ) / \vec{γ} , \qquad [ Math . 5 ]$$

a fifth calculation unit of each secure computation apparatus securely computes the following formula to update the secret value of the matrix P

$$P ← R + {\vec{β}}^{T} P , \qquad [ Math . 6 ]$$

and
a sixth calculation unit of each secure computation apparatus securely computes the following formula while converting multiplication of N values into element-wise multiplication one vector, to update the secret value of the vector γ^{→}

$$\vec{γ} ← diag ( {R}^{T} R ) . \qquad [ Math . 7 ]$$

### Effects of the Invention

According to the present invention, the conjugate gradient method computation for a plurality of sets of symmetric positive definite matrices and vectors can be a single computation, which is efficient.

### BRIEF DESCRIPTION OF THE DRAWINGS

FIG. 1 is a diagram illustrating a functional configuration of a secure conjugate gradient method computation system.

FIG. 2 is a diagram illustrating a functional configuration of a secure computation apparatus.

FIG. 3 is a diagram illustrating a processing procedure of a secure conjugate gradient method computation method.

FIG. 4 is a diagram illustrating a functional configuration of a computer.

### DETAILED DESCRIPTION OF THE EMBODIMENTS

First, notation and definitions of terms in the present description will be described.

### Notation

Symbols “^{→}” (upper right arrow) and “˜” (tilde) used in sentences would normally be placed directly above the immediately preceding letters, but are placed immediately after the letters due to restrictions of text expression. In formulas, these symbols are in their normal positions thereof, that is, directly above the letters. For example, “a^{→}” and “C˜” are represented as follows in formulas.

$$\vec{a} , \tilde{C} \qquad [ Math . 8 ]$$

A letter with “^{→}” (upper right arrow) represents a vector. For example, a vector consisting of N values a₁, a₂, . . . , aₙ is expressed as a^{→}=(a₁, a₂, . . . , aₙ). A vector element number is indicated by a subscript. For example, an i-th element of the vector a^{→} is denoted as aᵢ.

When there is a vector represented by a lowercase letter, the corresponding capital letter represents a matrix consisting of a plurality of vectors. For example, a matrix consisting of N vectors b^{→}₁, b^{→}₂, . . . , b^{→}_{N} is expressed as B=(b^{→}₁, b^{→}₂, . . . , b^{→}_{N}).

The vector element number is represented by a subscript, but when the subscript representing the vector number is added to a vector, the subscripts shall be separated by a comma, and the vector number and the vector element number are described together. For example, a j-th element of an i-th vector b^{→}₁ is denoted as b^{→}_{i,j}.

A capital letter with “˜” (tilde) represents a multi-dimensional matrix. For example, a multi-dimensional matrix with N matrices C₁, C₂, . . . , C_{N} is denoted as C˜=(C₁, C₂, . . . , C_{N}).

[⋅] represents a secret text obtained by encrypting the value “⋅”. When the encryption is performed by secret sharing, this is called a “share.”

α→β represents conversion from α to β.

α←β represents substituting β into α.

⋅^{T} (superscript T) represents a transpose of the matrix “⋅”.

α^{→T}β^{→} represents an inner product of a vector α^{→} and a vector β^{→}.

### Secure Computation

There is a method called secure computation as a method of obtaining a specific calculation result without restoring encrypted numerical values (see Reference 1, for example). In the method described in Reference 1, encryption for distributing fragments of the numerical values to three secure computation apparatuses is performed, and the three secure computation apparatuses perform cooperative calculation, making it possible to keep the result of addition and subtraction, constant addition, multiplication, constant multiple, a logical operation (negative, logical product, logical sum, or exclusive logical sum), and data format conversion (integer or binary) distributed to the three secure computation apparatuses without restoring the numerical values, that is, to keep the results remain encrypted.

[Reference 1] Koji Chida et al., “A Three-Party Secure Function Evaluation with Lightweight Verifiability Revisited,” Computer Security Symposium 2010, 2010.

### Conventional Conjugate Gradient Method

An algorithm of the conventional conjugate gradient method (Algorithm 1) is shown below. This algorithm receives the symmetric positive definite matrix A, the vector b^{→}, and a threshold value δ, and outputs a calculation result of A⁻¹b^{→}. When the conjugate gradient method is performed by secure computation, all values “⋅” handled in the algorithm only need to be replaced with share [⋅].

TABLE 1

Algorithm 1: Conventional conjugate gradient method
Input: A, \vec{b}, δ
Output: A⁻¹ \vec{b} ← \vec{x}
1. \vec{x} ← 0ⁿ
2. \vec{r}, \vec{p} ← \vec{b}
3. R ← \vec{r}^{T}\vec{r}
While R > δ do
$4. α ← \frac{{\vec{r}}^{T} \vec{p}}{{\vec{p}}^{T} A \vec{p}}$
5. \vec{x} ← \vec{x} + α\vec{p}
6. \vec{r} ← \vec{r} − αA\vec{p}
$7. β ← \frac{R}{R}$
8. \vec{p} ← \vec{r} + β\vec{p}
9. R ← \vec{r}^{T}\vec{r}
end

Here, 0ⁿ represents a vector having a length of n with all elements being zero.

### Proposed Conjugate Gradient Method

An algorithm of the conjugate gradient method proposed by the present invention (algorithm 2) will be shown hereinafter. This algorithm receives a multi-dimensional matrix A˜=(A₁, A₂, . . . , A_{N}) consisting of N symmetric positive definite matrices A₁, A₂, . . . , A_{N}, a matrix B=(b^{→}₁, b^{→}₂, . . . , b^{→}_{N}) consisting of N vectors b^{→}₁, b^{→}₂, . . . , b^{→}_{N}, and the number of iterations δ, and outputs a matrix X=(x^{→}₁, x^{→}₂, . . . , x^{→}_{N}) consisting of N vectors x^{→}₁, x^{→}₂, . . . , x^{→}_{N} (where x^{→}₁=A₁⁻¹b^{→}ᵢ, i=1, . . . , N).

TABLE 2

Algorithm 2: Proposed conjugate gradient method
Input: Ã = (A₁, . . . , A_{N}), B = (\vec{b}₁, . . . , \vec{b}_{N}), δ
Output: X = (A₁⁻¹\vec{b}₁, . . . , A_{N}⁻¹\vec{b}_{N})
1. X ← (0ⁿ, 0ⁿ, . . . , 0ⁿ)
2. R, P ← B
3. \vec{γ} ← diag(R^{T} R)
for j = 1, . . . , δ do
$4. operate ( {α}_{i} ← \frac{{{\vec{r}}_{i}}^{T} {\vec{p}}_{i}}{{{\vec{p}}_{i}}^{T} A {\vec{p}}_{i}} , i ∈ \{ 1 , … , N \} ) collectively$
5. X ← X + \vec{α}^{T} P
6. operate (\vec{r}ᵢ ← \vec{r}ᵢ − αᵢAᵢ\vec{p}ᵢ, i ∈ {1, . . . , N}) collectively
$7. \vec{β} ← \frac{diag ( {R}^{T} R )}{\vec{γ}}$
8. P ← R + \vec{β}^{T} P
9. \vec{γ} ← diag (R^{T} R)
end

Here, diag (⋅) is a function that outputs the diagonal elements of a matrix “⋅”.

Element technologies 1 and 2 below are used to calculate algorithm 2. Element technology 1 is a method of collectively calculating an inner product of a plurality of vectors. Element technology 2 is a method of collectively calculating a plurality of vectors and matrices. Element technology 1 is used to calculate steps 3, 7, and 9 of algorithm 2. Element technology 2 is used to calculate steps 4 and 6 of algorithm 2.

### Element Technology 1: Method of Collectively Calculating Inner Product of Vectors

Element technology 1 is a technique for calculating e^{→}←C⁷D=(c^{→}₁⁷d^{→}₁, c^{→}₂⁷d^{→}₂, . . . , c^{→}_{N}⁷d^{→}_{N}) when a matrix C=(c^{→}₁, c^{→}₂, . . . , c^{→}_{N}) and a matrix D=(d^{→}₁, d^{→}₂, . . . , d^{→}_{N}) are given. All of the respective vectors (c^{→}₁, c^{→}₂, . . . , c^{→}_{N}) and (d^{→}₁, d^{→}₂, . . . , d^{→}_{N}) included in the matrices C and D have a length n. Here, n is a predetermined natural number.

First, the vectors that are the elements of the matrix C and the matrix D are concatenated to generate concatenated vectors c^{→} and d^{→}.

C=(c^{→}₁, c^{→}₂, . . . , c^{→}_{N})→c^{→}=(c_{1,1}, c_{1,2}, . . . , c_{1,n}, c_{2,1}, c_{2,2}, . . . , c_{2,n}, . . . , c_{N,1}, c_{N,2}, . . . , c_{N,n})

D=(d^{→}₁, d^{→}₂, . . . , d^{→}_{N})→d^{→}=(d_{1,1}, d_{1,2}, . . . , d_{1,n}, d_{2,1}, d_{2,2}, . . . , d_{2,n}, . . . , d_{N,1}, d_{N,2}, . . . , d_{N,n})

Next, the matrix C and the matrix D are multiplied element by element to generate an element product vector g^{→}.

g^{→}←c^{→}×d^{→}=(c_{1,1}×d_{1,1}, c_{1,2}×d_{1,2}, . . . , c_{1,n}×d_{1,n}, c_{2,1}×d_{2,1}, c_{2,2}×d_{2,2}, . . . , c_{2,n}×d_{2,n}, . . . , c_{N,1}×d_{N,1}, c_{N,2}×d_{N,2}, . . . , c_{N,n}×d_{N,n})

Finally, the elements of the element product vector g^{→} are divided into n pieces and the n elements are summed to generate a resultant vector e^{→}.

e^{→}←(sum(c_{1,1}×d_{1,1}, c_{1,2}×d_{1,2}, . . . , c_{1,n}×d_{1,n}), sum(c_{2,1}×d_{2,1}, c_{2,2}×d_{2,2}, . . . , c_{2,n}×d_{2,n}), . . . , sum(c_{N,1}×d_{N,1}, c_{N,2}×d_{N,2}, . . . , c_{N,n}×d_{N,n}))

In the conventional method, N times of multiplication of values are required to calculate an inner product of N vector pairs. Using element technology 1, an inner product of N vector pairs can be calculated by a single element-wise multiplication. In secure computation, both the multiplication of values and the element-wise multiplication of vectors require one communication. Therefore, when the multiplication of N values is converted into element-wise multiplication of vectors having N elements, the number of communications can be reduced to 1/N. In the secure computation, particularly, the multiplication requires a large amount of communication. Reducing the number of multiplications can greatly speed up processing.

### Element Technology 2: Method for Collectively Calculating Vector and Matrix

Element technology 2 is a technique for calculating F←(c^{→}₁^{T}D₁, c^{→}₂^{T}D₂, . . . , c^{→}_{N}^{T}D_{N}) when a matrix C=(c^{→}₁, c^{→}₂, . . . , c^{→}_{N}) and multi-dimensional matrices D˜=(D₁, D₂, . . . , D_{N}) are given.

When matrix calculation is performed by secure computation, local operation consisting of multiplication and addition is performed on share, and then a result of the local operation is communicated between parties. Therefore, when N matrix calculations are performed in the conventional way, it is necessary to perform N communications. If local operations required for each of the N matrix calculations are first collectively performed, and then the communication required for each matrix calculation is collectively performed once, it is possible to perform N matrix calculations in one communication. Since communication becomes a bottleneck in secure computation, reducing the number of communications can speed up processing.

Hereinafter, embodiments of the present invention will be described in detail. In the drawings, constituent units having the same function are denoted by the same reference signs, and repeated description is omitted.

### Embodiments

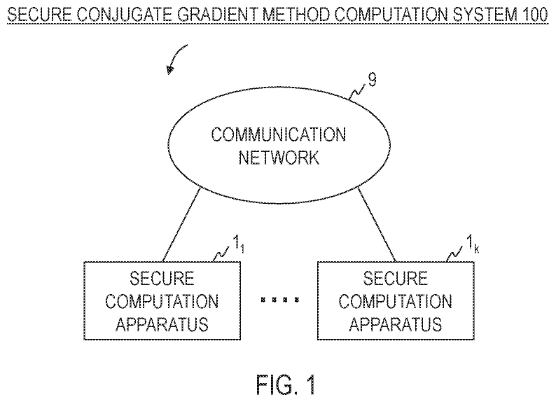

A configuration example of a secure conjugate gradient method computation system according to the embodiment will be described with reference to FIG. 1. The secure conjugate gradient method computation system 100 includes, for example, K (≥2) secure computation apparatuses 1₁, . . . , 1_{K}, as illustrated in FIG. 1. In the present embodiment, the secure computation apparatuses 1₁, . . . , 1_{K}, are connected to a communication network 9. The communication network 9 is a circuit-switched or packet-switched communication network configured so that connected apparatuses can communicate with each other and, for example, the Internet, a local area network (LAN), or a wide area network (WAN) can be used. Each apparatus does not necessarily need to be able to communicate online via the communication network 9. For example, a configuration in which information to be input to the secure computation apparatuses 1₁, . . . , 1_{K}, is stored in a portable recording medium such as a magnetic tape or a USB memory, and is input offline from the portable recording medium to the secure computation apparatuses 1₁, . . . , 1_{K}, may be adopted.

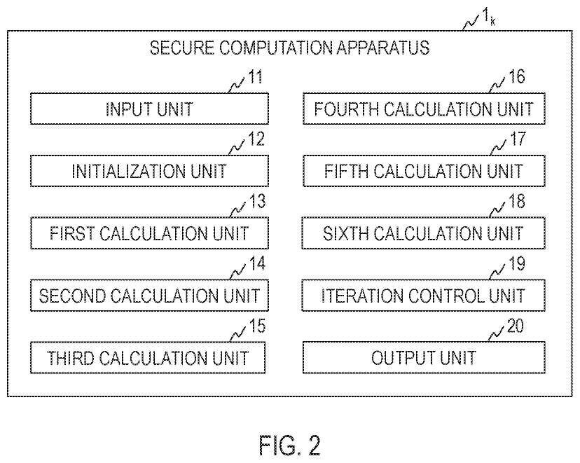

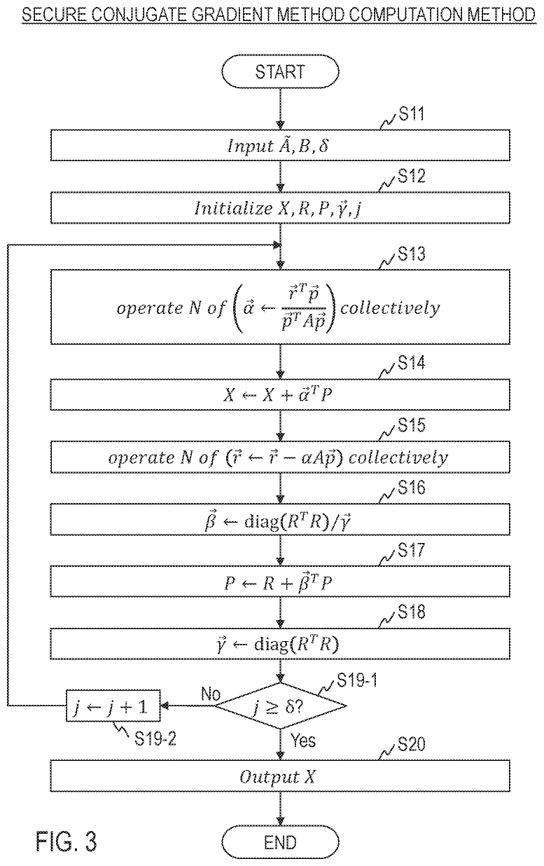

A configuration example of a secure computation apparatus 1ₖ (k=1, . . . , K) included in the secure conjugate gradient method computation system 100 of the embodiment will be described with reference to FIG. 2. The secure computation apparatus 1ₖ includes, for example, an input unit 11, an initialization unit 12, a first calculation unit 13, a second calculation unit 14, a third calculation unit 15, a fourth calculation unit 16, a fifth calculation unit 17, a sixth calculation unit 18, an iteration control unit 19, and an output unit 20, as illustrated in FIG. 2. This secure computation apparatus 1ₖ (k=1, . . . , K) cooperates with another secure computation apparatus 1_{k′} (k′=1, . . . , K, where k≠k′) to perform processing of each step illustrated in FIG. 3, so that the secure conjugate gradient method computation method of the present embodiment is realized.

The secure computation apparatus is, for example, a special device configured by a special program being loaded into a known or dedicated computer including a central processing unit (CPU), a main storage (RAM: Random Access Memory), and the like. The secure computation apparatus, for example, executes each processing under control of the central processing unit. Data input to the secure computation apparatus or data obtained in each processing is stored in, for example, the main storage, and the data stored in the main storage is loaded onto the central processing unit as necessary and used for other processing. At least a part of each processing unit of the secure computation apparatus may be configured by hardware such as an integrated circuit.

A processing procedure of the secure conjugate gradient method computation method executed by the secure conjugate gradient method computation system 100 of the embodiment will be described with reference to FIG. 3. In formulas in the following description, brackets ([]) representing secret values are omitted in order to simplify expressions, but all values, vectors, and matrices are assumed to be made secret.

In step S11, a secret value [A˜] of the multi-dimensional matrix A˜=(A₁, A₂, . . . , A_{N}) consisting of the N symmetric positive definite matrices A₁, A₂, . . . , A_{N}, a secret value [B] of a matrix B=(b^{→}₁, b^{→}₂, . . . , b^{→}_{N}) consisting of N vectors b^{→}₁, b^{→}₂, . . . , b^{→}_{N}, and a secret value [δ] of the number of iterations δ are input to the input unit 11 of each secure computation apparatus 1ₖ. The number of iterations o may be set in consideration of the accuracy of a calculation result and a processing speed, but it is known that the number of iterations δ only needs to be set to about 10 in the conjugate gradient method. The secret value [A^{˜}] of the multi-dimensional matrix A^{˜} is output to the first calculation unit 13. The secret value [B] of the matrix B is output to the initialization unit 13. A secret value [δ] of the number of iterations δ is output to the iteration control unit 19.

In step S12, the initializing unit 12 of each secure computation apparatus 1ₖ securely computes Formula (1), (2), and (3) to generate a secret value [X] of a matrix X=(x^{→}₁, . . . , x^{→}_{N}) consisting of N vectors x^{→}₁, . . . , x^{→}_{N}, a secret value [R] of a matrix R=(r^{→}₁, . . . , r^{→}_{N}) consisting of N vectors r^{→}₁, . . . , r^{→}_{N}, a secret value [P] of a matrix P=(p^{→}₁, . . . , p^{→}_{N}) consisting of N vectors p^{→}₁, . . . , p^{→}_{N}, and a secret value [γ^{→}] of a vector γ^{→}. The respective vectors (x^{→}₁, . . . x^{→}_{N}), (r^{→}₁, . . . , r^{→}_{N}), and (p^{→}₁, . . . , p^{→}_{N}) included in the matrices X, R, and P, and vector γ^{→} have a length n. Further, the initialization unit 12 initializes the index j of the iteration to j=1. The generated secret value [X] of the matrix X is output to the second calculation device 14. The generated secret values [R] and [P] of the matrices R and P are output to the first calculation unit 13. The generated secret value [γ^{→}] of the vector γ^{→} is output to the fourth calculation unit 16.

$$\begin{matrix}[ Math . 9 ] & \\ X ← ( {0}^{n} , {0}^{n} , … , {0}^{n} ) & ( 1 )\end{matrix}$$

$$R , P ← B \qquad ( 2 )$$

$$\vec{γ} ← diag ( {R}^{T} R ) \qquad ( 3 )$$

The initialization unit 12 securely computes R^{T}R of Formula (3) while converting N multiplications into element-wise multiplication of one vector using the element technology 1. That is, when R^{T}R of Formula (3) is calculated, the following procedure is executed. First, the vectors r^{→}₁, r^{→}₂, . . . , r^{→}_{N} included in the matrix R are concatenated to generate a concatenated vector r^{→}=(r_{1,1}, . . . , r_{1,n}, r_{2,1}, . . . , r_{2,n}, . . . , r_{N,1}, . . . , r_{N,n}). Next, the two concatenated vectors r^{→} are multiplied element by element to generate an element product vector g^{→}←r^{→}×r^{→}=(r_{1,1}×r_{1,1}, . . . , r_{1,n}×r_{1,n}, r_{2,1}×r_{2,1}, . . . , r_{2,n}×r_{2,n}, . . . , r_{N,1}×r_{N,1}, . . . , r_{N,n}×r_{N,n}). Finally, the elements of the element product vector g^{→} are divided into n pieces, and the n elements are summed to generate a resultant vector e^{→}←(sum(r_{1,1}×r_{1,1}, . . . , r_{1,n}×r_{1,n}), sum(r_{2,1}×r_{2,1}, . . . , r_{2,n}×r_{2,n}), . . . , sum(r_{N,1}×r_{N,1}, . . . , r_{N,n}×r_{N,n})).

In step S13, the first calculation unit 13 of each secure computation apparatus 1ₖ securely computes Formula (4), where integer i is equal to or greater than 1 and equal to or smaller than N, collectively to generate the secret value [α^{→}] of the vector α^{→}=(α₁, . . . , α_{N}). The generated secret value [α^{→}] of the vector α^{→} is output to the second calculation unit 14.

$$\begin{matrix}[ Math . 10 ] & \\ {α}_{i} ← \frac{{\vec{r}}_{i}^{T} {\vec{p}}_{i}}{{\vec{p}}_{i}^{T} {A}_{i} {\vec{p}}_{i}} & ( 4 )\end{matrix}$$

The first calculation unit 13 securely computes p^{→}ᵢ^{T}Aᵢp^{→}ᵢ in Formula (4) so that communication required for N matrix calculations is collectively performed once by using the element technology 2. That is, local operations necessary for each of p^{→}ᵢ^{T}Aᵢp^{→}ᵢ are collectively performed first, and then the communication required for each of p^{→}ᵢ^{T}Aᵢp^{→}ᵢ is collectively performed once.

In step S14, the second calculation unit 14 of each secure computation apparatus 1ₖ updates the secret value [X] of the matrix X by securely computing Formula (5). The updated secret value [X] of the matrix X is output to the output unit 20.

$$\begin{matrix}[ Math . 11 ] & \\ X ← X + {\vec{α}}^{T} P & ( 5 )\end{matrix}$$

In step S15, the third calculation unit 15 of each secure computation apparatus 1ₖ securely computes Formula (6), where integer i is equal to or greater than 1 and equal to or smaller than N, collectively to update the secret value [R] of the matrix R. The updated secret value [R] of matrix R is output to the iteration control unit 19.

$$\begin{matrix}[ Math . 12 ] & \\ {\vec{r}}_{i} ← {\vec{r}}_{i} - {α}_{i} {A}_{i} {\vec{p}}_{i} & ( 6 )\end{matrix}$$

The third calculation unit 15 securely computes Aᵢp^{→}ᵢ in Formula (6) so that communication required for N matrix calculations is collectively performed once by using the element technology 2, like the first calculation unit 13.

In step S16, the fourth calculation unit 16 of each secure computation apparatus 1ₖ securely computes Formula (7) to generate a secret value [β^{→}] of the vector β^{→}. The generated secret value [β^{→}] of the vector β^{→} is output to the fifth calculation unit 17.

$$\begin{matrix}[ Math . 13 ] & \\ \vec{β} ← diag ( {R}^{T} R ) / \vec{γ} & ( 7 )\end{matrix}$$

The fourth calculation unit 16 securely computes R^{T}R of Formula (7) while converting N multiplications into element-wise multiplications of one vector using the element technology 1, like the initialization unit 12.

In step S17, the fifth calculation unit 17 of each secure computation apparatus 1ₖ securely computes Formula (8) to update the secret value [P] of the matrix P. The updated secret value [P] of the matrix P is output to the first calculation device 13.

$$\begin{matrix}[ Math . 14 ] & \\ P ← R + {\vec{β}}^{T} P & ( 8 )\end{matrix}$$

In step S18, the sixth calculation unit 18 of each secure computation apparatus 1ₖ securely computes Formula (9) to update the secret value [γ^{→}] of the vector γ^{→}. The updated secret value [γ^{→}] of the vector γ^{→} is output to the fourth calculation unit 16.

$$\begin{matrix}[ Math . 15 ] & \\ \vec{γ} ← diag ( {R}^{T} R ) & ( 9 )\end{matrix}$$

The sixth calculation unit 18 securely computes R^{T}R of Formula (9) while converting N multiplications into element-wise multiplications of one vector using the element technology 1, like the initialization unit 12.

In step S19-1, the iteration control unit 19 of each secure computation apparatus 1ₖ determines whether or not the index j is equal to or greater than the number of iterations δ, that is, whether j≥δ is true or false. When j≥δ is false, that is, when j<δ, the processing advances to step S19-2. When j≥δ is true, the processing advances to step S20. In step S19-2, the iteration control unit 19 of each secure computation apparatus 1ₖ increments j, that is, calculates j←j+1, and returns to processing of step S13. In other words, the iteration control unit 19 controls to repeatedly execute the processing from the first calculation unit 13 to the sixth calculation unit 18 δ times.

In step S20, the output unit 20 of each secure computation apparatus 1ₖ outputs the secret value [X] of the matrix X as a secret value of A₁⁻¹b^{→}₁, A₂⁻¹b^{→}₂, . . . , A_{N}⁻¹b^{→}_{N}.

### EXAMPLE 1

Example 1 of the present invention is an example in which linear regression is solved using the conjugate gradient method of algorithm 2. An equation for obtaining a linear regression model is Equation (10).

$$\begin{matrix}[ Math . 16 ] & \\ W = {( {X}^{T} X )}^{- 1} {X}^{T} \vec{y} & ( 10 )\end{matrix}$$

Equation (10) is typically solved using the conjugate gradient method because processing of an inverse matrix is heavy. By using the conjugate gradient method of algorithm 2, it is possible to collectively learn a plurality of linear regression models using different data sets by one execution of conjugate gradient method.

### EXAMPLE 2

Example 2 of the present invention is an example in which ridge regression is solved using the conjugate gradient method of algorithm 2. An equation for obtaining a ridge regression model is Equation (11).

$$\begin{matrix}[ Math . 17 ] & \\ W = {( {X}^{T} X + α I )}^{- 1} {X}^{T} \vec{y} & ( 11 )\end{matrix}$$

α in Equation (11) represents a hyperparameter. Conventionally, an arbitrary value is set to α and then learning is performed. Since an optimal hyperparameter value is not known in advance, a problem is that it is necessary to set a plurality of different hyperparameters and perform learning many times. By using the conjugate gradient method of algorithm 2, it is possible to collectively learn plural ridge regression models having different hyperparameters by one execution of conjugate gradient method. This makes it possible to efficiently learn an optimal model.

Although the embodiments of the present invention have been described above, a specific configuration is not limited to these embodiments and it is obvious that even if a design were appropriately changed without departing from the spirit of the present invention, such changes would be included in the present invention. Various processing described in the embodiments may be not only executed in chronological order according to an order of description, but may also be executed in parallel or individually according to a processing capacity of a device that executes processing or as necessary.

### Program and Recording Medium

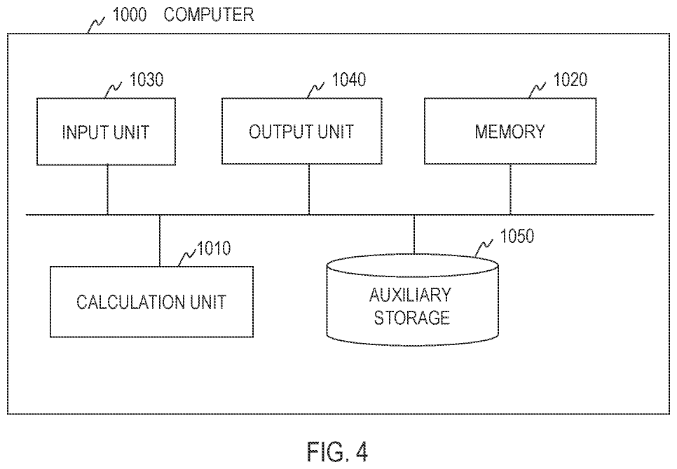

When various processing functions in each apparatus described in the above embodiment are realized by a computer, processing content of the functions to be included in each apparatus is described by a program. This program is loaded into an auxiliary storage 1050 of the computer illustrated in FIG. 4 and operated by a calculation unit 1010, an input unit 1030, an output unit 1040, and the like, so that various processing functions of the above apparatuses are realized on the computer.

A program in which processing content thereof has been described can be recorded on a computer-readable recording medium. The computer-readable recording medium is, for example, a non-transitory recording medium, such as a magnetic recording device or an optical disc.

Further, distribution of this program may be performed, for example, by selling, transferring, or renting a portable recording medium such as a DVD or CD-ROM on which the program has been recorded. Further, the program may be distributed by storing the program in a storage of a server computer and transferring the program from the server computer to another computer via a network.

The computer that executes such a program first temporarily stores, for example, the program recorded on the portable recording medium or the program transferred from the server computer in an auxiliary storage 1050, which is a non-transitory storage of the computer. When processing is executed, this computer loads the program stored in the auxiliary storage 1050, which is the non-transitory storage of the computer, onto the memory 1020, which is a transitory storage, and executes processing according to the loaded program. Further, as another execution form of the program, the computer may directly read the program from the portable recording medium and execute the processing according to the program, and further, processing according to a received program may be sequentially executed each time the program is transferred from the server computer to the computer. Further, a configuration in which the above-described processing is executed by a so-called application service provider (ASP) type service for realizing a processing function according to only an execution instruction and result acquisition without transferring the program from the server computer to the computer may be adopted. It is assumed that the program in the present embodiment includes information provided for processing of an electronic calculator and being equivalent of the program (such as data that is not a direct command to the computer, but has properties defining processing of the computer).

Further, in above description, the apparatus described in the embodiments is configured by a predetermined program being executed on the computer, but at least a part of processing content thereof may be realized by hardware.

1. A secure conjugate gradient method computation method for receiving a secret value of a multi-dimensional matrix A˜ consisting of N symmetric positive definite matrices A₁, A₂, . . . , A_{N} and a secret value of a matrix B consisting of N vectors b^{→}₁, . . . , b^{→}_{N} and outputting a secret value of a matrix X consisting of A₁⁻¹b^{→}₁, . . . , A_{N}⁻¹b^{→}_{N}, the secure conjugate gradient method computation method being executed by a secure conjugate gradient method computation system including a plurality of secure computation apparatuses, wherein ⋅^{T} represents a transpose of a matrix ⋅, diag (⋅) represents a function for outputting diagonal elements of the matrix ⋅, n represents a predetermined natural number, and 0ⁿ represents a vector having a length of n with all elements being 0,
an initialization circuitry of each secure computation apparatus securely computes the following formulas to generate a secret value of the matrix X, a secret value of a matrix R=(r^{→}₁, . . . , r^{→}_{N}), a secret value of a matrix P=(p^{→}₁, . . . , p^{→}_{N})), and a secret value of a vector γ^{→}.
$$\\ \begin{matrix}X ← ( {0}^{{}_{} n} , {0}^{{}_{} n} , … , {0}^{{}_{} n} ) & [ Math . 18 ]\end{matrix}$$
$$\\ R , P ← B$$
$$\\ \vec{γ} ← diag ( {R}^{{}_{} T} R )$$
a first calculation circuitry of each secure computation apparatus securely computes the following formula so that communication required for matrix calculation is collectively performed once for integer i equal to or greater than 1 or equal to or smaller than N, to generate a secret value of a vector α^{→}=(α₁, . . . , α_{N})
$${α}_{i} ← \frac{{\vec{r}}_{i}^{T} \vec{p} i}{{\vec{p}}_{i}^{T} {A}_{i} {\vec{p}}_{i}} , \qquad [ Math . 19 ]$$
a second calculation circuitry of each secure computation apparatus securely computes the following formula to update the secret value of the matrix X
$$X ← X + {\vec{α}}^{{}_{T}} P , \qquad [ Math . 20 ]$$
a third calculation circuitry of each secure computation apparatus securely computes the following formula so that the communication required for the matrix calculation is collectively performed once for integer i equal to or greater than 1 or equal to or smaller than N, to update a secret value of the matrix R
$${\vec{r}}_{i} ← {\vec{r}}_{i} - {α}_{i} {A}_{i} {\vec{p}}_{i} , \qquad [ Math . 21 ]$$
a fourth calculation circuitry of each secure computation apparatus securely computes the following formula while converting multiplication of N values into element-wise multiplication of one vector to generate a secret value of the vector β^{→}
$$\vec{β} ← diag ( {R}^{T} R ) / \vec{γ} , \qquad [ Math . 22 ]$$
a fifth calculation circuitry of each secure computation apparatus securely computes the following formula to update the secret value of the matrix P,
$$P ← R + {\vec{β}}^{{}_{{}_{T}}} P , \qquad [ Math . 23 ]$$
and a sixth calculation circuitry of each secure computation apparatus securely computes the following formula while converting multiplication of N values into element-wise multiplication of one vector, to update the secret value of the vector γ^{→}
$$\vec{γ} ← diag ( {R}^{T} R ) \qquad [ Math . 24 ]$$

2. The secure conjugate gradient method computation method according to claim 1,
wherein the initialization circuitry, the fourth calculation circuitry, and the sixth calculation circuitry
generate a concatenated vector r^{→} obtained by concatenating vectors r^{→}₁, . . . , r^{→}_{N} included in the matrix R, generate an element product vector g^{→} obtained by multiplying two concatenated vectors r^{→} element by element, divide elements of the element product vector g^{→} into n pieces, sum each n pieces of elements, and obtain a resultant vector e to calculate R^{T}R.

3. The secure conjugate gradient method computation method according to claim 1,
wherein the first calculation circuitry and the third calculation circuitry collectively perform N local operations required for matrix calculation by secure computation when a vector p i included in the matrix P and a symmetric positive definite matrix Aᵢ included in the multi-dimensional matrix A˜ are subjected to the matrix calculation, for integer i equal to or greater than 1 or equal to or smaller than N, and collectively perform communication required for the matrix calculation as one communication.

4. A secure conjugate gradient method computation system including a plurality of secure computation apparatuses, receiving a secret value of a multi-dimensional matrix A˜ consisting of N symmetric positive definite matrices A₁, . . . , A_{N} and a secret value of a matrix B consisting of N vectors b^{→}₁, . . . , b^{→}_{N}, and outputting a secret value of a matrix X consisting of A₁⁻¹b^{→}₁, . . . , A_{N}⁻¹b^{→}_{N},
wherein ⋅^{T} represents a transpose of a matrix ⋅, diag (⋅) represents a function for outputting diagonal elements of the matrix ⋅, n represents a predetermined natural number, and 0ⁿ represents a vector having a length of n with all elements being 0, and
each secure computation apparatus includes
an initialization circuitry configured to securely compute the following formulas to generate a secret value of the matrix X, a secret value of a matrix R=(r^{→}₁, . . . , r^{→}_{N}), a secret value of a matrix P=(p^{→}₁, . . . , p^{→}_{N})), and a secret value of a vector γ^{→},
$$X ← ( {0}^{n} , {0}^{n} , … , {0}^{n} ) R , P ← B \vec{γ} ← diag ( {R}^{T} R ) \qquad [ Math . 25 ]$$
a first calculation circuitry configured to securely compute the following formula so that communication required for matrix calculation is collectively performed once for integer i equal to or greater than 1 or equal to or smaller than N, to generate a secret value of a vector α^{→}=(α₁, . . . , α_{N})
$${α}_{i} ← \frac{{\vec{r}}_{i}^{T} \vec{p} i}{{\vec{p}}_{i}^{T} {A}_{i} {\vec{p}}_{i}} ; \qquad [ Math . 26 ]$$
a second calculation circuitry configured to securely compute the following formula to update the secret value of the matrix X,
$$X ← X + {\vec{α}}^{{}_{T}} P ; \qquad [ Math . 27 ]$$
a third calculation circuitry configured to securely compute the following formula so that the communication required for the matrix calculation is collectively performed once for integer i equal to or greater than 1 or equal to or smaller than N, to update a secret value of the matrix R
$${\vec{r}}_{i} ← {\vec{r}}_{i} - {α}_{i} {A}_{i} {\vec{p}}_{i} ; \qquad [ Math . 28 ]$$
a fourth calculation circuitry configured to securely compute the following formula while converting multiplication of N values into element-wise multiplication of one vector to generate a secret value of the vector β→
$$\vec{β} ← diag ( {R}^{T} R ) / \vec{γ} ; \qquad [ Math . 29 ]$$
a fifth calculation circuitry configured to securely compute the following formula to update the secret value of the matrix P
$$P ← R + \vec{β} {}^{{}_{{}_{{}_{{}_{} T}}}} P ; \qquad [ Math . 30 ]$$
and a sixth calculation circuitry configured to securely compute the following formula while converting multiplication of N values into element-wise multiplication of one vector, to update the secret value of the vector γ→
$$\vec{γ} ← diag ( {R}^{T} R ) \qquad [ Math . 31 ]$$

5. A secure computation apparatus used in the secure conjugate gradient method computation system according to claim 4.

6. A non-transitory computer-readable recording medium which stores a program for causing a computer to execute each step of the secure conjugate gradient method computation method according to claim 1.
